(19) United States
(12) Patent Application Publication
(10) Pub. No.: US 2019/0075171 A1
(43) Pub. Date: Mar. 7, 2019

(54) System and Method for Generating Marker Data

(71) Applicant: EtherLabs, Inc., Austin, TX (US)

(72) Inventors: Cullen Childress, Austin, TX (US); Krishna Sai, Round Rock, TX (US)

(21) Appl. No.: 15/926,681

(22) Filed: Mar. 20, 2018

Related U.S. Application Data
(60) Provisional application No. 62/554,387, filed on Sep. 5, 2017.

(51) Int. Cl. H04L 29/08; H04L 29/06; H04W 4/08

(52) U.S. Cl. CPC H04L 67/146; H04L 65/1066; H04W 4/08; H04L 67/42

(57) ABSTRACT

A method includes establishing, by a server device, an asynchronous communication channel accessible to a plurality of devices. The method further includes receiving, via the asynchronous communication channel, a request to initiate a synchronous communication session. The method further includes, during the synchronous communication session, generating, at the server device, marker data indicating a segment of the synchronous communication session and outputting an indicator associated with the marker data to at least one device of the plurality of devices.

### TECHNICAL FIELD

The present disclosure relates to communication systems.

### BACKGROUND

In the modern world, groups of people collaborate on various projects from distinct locations. For example, a business may include teams located in different cities or countries. Such teams may be tasked with collaborating to accomplish various goals of the business. Even members of a particular team may be distributed across multiple locations. For example, some members may work from home while others work from an office building. In order to facilitate collaboration between team members and/or teams in various locations, businesses use different communication technologies. Such communication technologies include asynchronous solutions, such as chat rooms, E-mail, etc., and synchronous solutions, such as audio/video calls. Asynchronous communications may be referenced during a synchronous communication session and vice versa. For example, team members may view and discuss a particular E-mail message during a conference call, or a chat communication may refer to discussions from a prior audio/video call. However, a single synchronous communications session may have a relatively long runtime during which many topics may be discussed and many decisions may be reached. Therefore, referring back to or accessing a particular portion of a recorded synchronous communication session at a later time may be difficult. Accordingly, information conveyed during synchronous communication sessions may be lost or difficult to find.

### SUMMARY

Systems and methods of generating marker data are disclosed. The disclosed systems and methods enable a user or a system to create marker data identifying a particular segment of a synchronous communication session. The disclosed systems and methods distribute an indicator of the marker data to a device enabling the device to access data (e.g., recorded audio data, video data, transcript data, etc.) associated with the segment. In one particular example, the indicator is distributed to an asynchronous communication channel automatically. In another particular example, the indicator is returned to the device in response to a search request from the device. Thus, the disclosed systems and methods enable reference and access to particular segments of synchronous communication sessions using marker data. Individuals who participated in the synchronous communication session as well as individuals who did not participate in the synchronous communication session can access a particular segment using the marker data. Therefore, the disclosed systems and methods promote retention of information in an organization and collaboration among people who did not participate in the synchronous communication session.

In a particular embodiment, an apparatus includes a processor and a computer-readable storage device storing instructions that, when executed by the processor, cause the processor to perform operations. The operations include establishing an asynchronous communication channel accessible to a plurality of devices. The operations further include receiving, via the asynchronous communication channel, a request to initiate a synchronous communication session. The operations further include, during the synchronous communication session, generating marker data indicating a segment of the synchronous communication session and outputting an indicator associated with the marker data to at least one device of the plurality of devices.

In another particular embodiment, a method includes establishing, by a server device, an asynchronous communication channel accessible to a plurality of devices. The method further includes receiving, via the asynchronous communication channel, a request to initiate a synchronous communication session. The method further includes, during the synchronous communication session, generating, at the server device, marker data indicating a segment of the synchronous communication session and outputting an indicator associated with the marker data to at least one device of the plurality of devices.

In another particular embodiment, a computer-readable storage device storing instructions that, when executed by a processor, cause the processor to perform operations including establishing, by a server device, an asynchronous communication channel accessible to a plurality of devices. The operations further include receiving, via the asynchronous communication channel, a request to initiate a synchronous communication session. The operations further include, during the synchronous communication session, generating, at the server device, marker data indicating a segment of the synchronous communication session and outputting an indicator associated with the marker data to at least one device of the plurality of devices.

### BRIEF DESCRIPTION OF DRAWINGS

For a more complete understanding of this disclosure, reference is now made to the following brief description, taken in connection with the accompanying drawings and detailed description, wherein like reference numerals represent like parts.

FIG. 1A is a block diagram illustrating a system for generating marker data;

FIG. 1B is another block diagram of the system for generating marker data;

FIG. 2 is a diagram illustrating an example of metadata fields associated with a marker;

FIG. 3 is a diagram of a logical representation of a system for generating and distributing markers;

FIG. 4 depicts a screen of a graphical user interface generated by a synchronous client;

FIG. 5 depicts another screen of the graphical user interface generated by the synchronous client;

FIG. 6 depicts a screen of a graphical user interface generated by an asynchronous client;

FIG. 7 depicts a third screen of the graphical user interface of the synchronous communication client;

FIG. 8 is a sequence diagram illustrating an example of a process of creating and using markers;

FIG. 9 is a diagram illustrating a logical representation of a system for automatically generating and distributing markers;

FIG. 10 depicts a screen generated by an asynchronous client and displaying auto generated markers;

FIG. 11 is a diagram illustrating relationships between elements, including markers, of an organization;

FIG. 12 is a table illustrating relationships between logical entities associated with information;

FIG. 13 is a diagram depicting storage of data related to a synchronous communication session;

FIG. 14 is a diagram illustrating a storage policy based on markers associated with a synchronous communication session;

FIG. 15 is a diagram illustrating a method of generating marker data; and

FIG. 16 is a block diagram illustrating a computing device that may be used for implementing the techniques described herein.

### DETAILED DESCRIPTION

In the following description, for purposes of explanation, numerous specific details are set forth in order to provide a thorough understanding of the embodiments disclosed herein. It will be apparent, however, to one skilled in the art that the disclosed embodiments may be practiced without these specific details. In other instances, structure and devices are shown in block diagram form in order to avoid obscuring the disclosed embodiments. References to numbers without subscripts or suffixes are understood to reference all instance of subscripts and suffixes corresponding to the referenced number. Moreover, the language used in this disclosure has been principally selected for readability and instructional purposes, and may not have been selected to delineate or circumscribe the inventive subject matter, resort to the claims being necessary to determine such inventive subject matter. Reference in the specification to “one embodiment” or to “an embodiment” means that a particular feature, structure, or characteristic described in connection with the embodiments is included in at least one embodiment.

The terms “a,” “an,” and “the” are not intended to refer to a singular entity unless explicitly so defined, but include the general class of which a specific example may be used for illustration. The use of the terms “a” or “an” may therefore mean any number that is at least one, including “one,” “one or more,” “at least one,” and “one or more than one.” The term “or” means any of the alternatives and any combination of the alternatives, including all of the alternatives, unless the alternatives are explicitly indicated as mutually exclusive. The phrase “at least one of” when combined with a list of items, means a single item from the list or any combination of items in the list. The phrase does not require all of the listed items unless explicitly so defined.

As used herein, the term “computing device” may refer to a device that includes, but is not limited to a single computer, host, server, laptop, and/or mobile device.

As used herein, the term “network device” may refer to any device that is capable of communicating and transmitting data to another device across any type of network.

As used herein, the term “computing system” may refer to a single electronic computing device or network device that includes, but is not limited to a single computer, virtual machine, virtual container, host, server, laptop, and/or mobile device. The term “computing system may also refer to a plurality of electronic computing devices and/or network devices working together to perform the function described as being performed on or by the computing system.

As used herein, the term “medium” refers to one or more non-transitory physical media that together store the contents described as being stored thereon. Embodiments may include non-volatile secondary storage, read-only memory (ROM), and/or random-access memory (RAM).

As used herein, the term “application” refers to one or more computing modules, programs, processes, workloads, threads and/or a set of computing instructions executed by a computing system. Example embodiments of an application include software modules, software objects, software instances and/or other types of executable code.

Sequences of method steps presented herein are provided as examples and are not meant to be limiting. Thus, methods may be performed in an order alternative to that illustrated in the figures and described herein. To illustrate, a method described as including steps “A” and “B” may be performed with “A” either preceding or following “B,” unless a specific order is indicated.

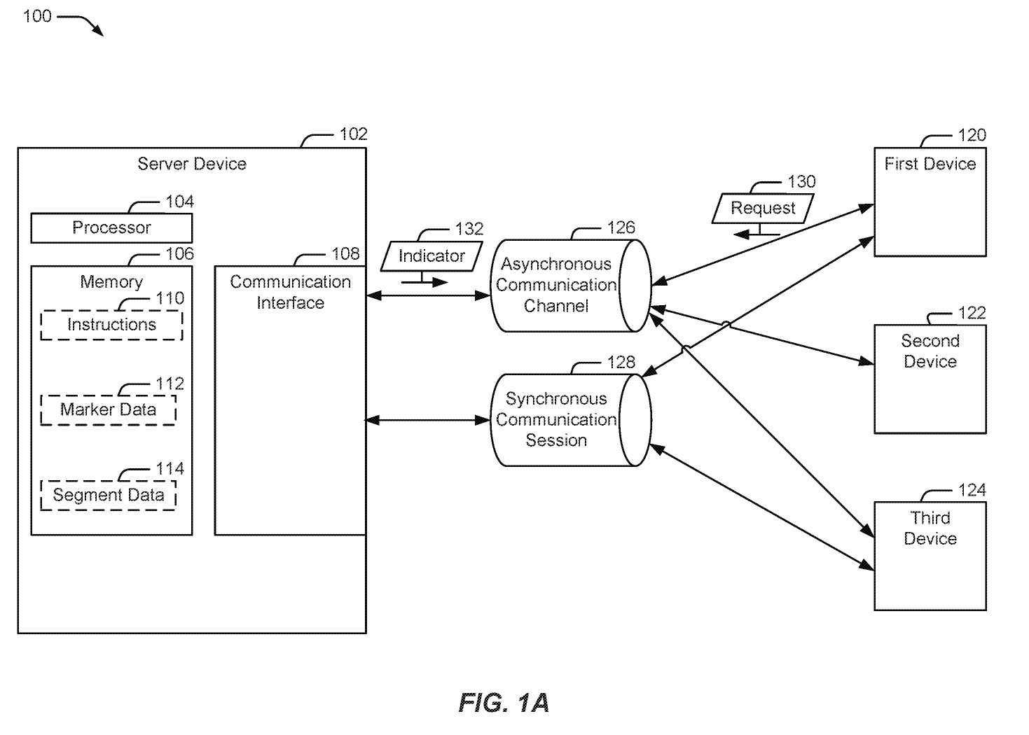

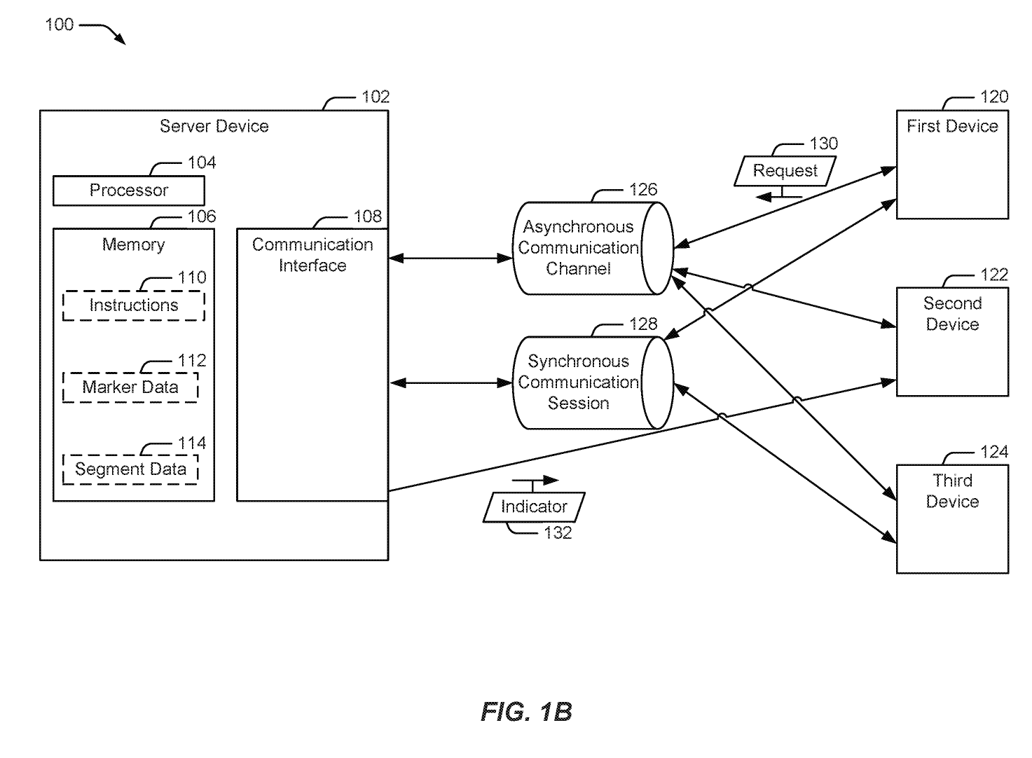

Referring to FIG. 1A, a block diagram illustrating a system 100 for generating marker data is shown. The system 100 includes a server device 102. The server device 102 includes a processor 104, a memory 106, and a communication interface 108, each of which is described further below. In some implementations, the server device 102 includes further components in addition to those illustrated.

The processor 104 corresponds to a one or more processing devices, such as one or more central processing units (CPUs), one or more other types of processing devices, or a combination thereof. The memory 106 corresponds to one or more computer-readable storage devices, such as one or more random-access memory devices, one or more optical devices (e.g., a compact disc, etc.), one or more hard disk drives, one or more flash memory devices, one or more other types of computer-readable storage devices, or a combination thereof. As used herein, a computer-readable storage device refers to a physical device. The memory 106 stores instructions 110 that are executable by the processor 104 to perform one or more of operations as described herein.

The communication interface 108 corresponds to one or more communication devices, such as one or more wireless interfaces (e.g., an 802.11 interface), one or more wired interfaces (e.g., an Ethernet interface), or a combination thereof. The server device 102 is configured to communicate with one or more devices via the communication interface 108. In the illustrated example, the server device 102 is configured to communicate with a first device 120, a second device 122, and a third device 124 via the communication interface 108. Each of the devices 120, 122, and 124 correspond to a different computing device. For example, the devices 120, 122, and 124 may include a mobile phone, a desktop computing, tablet computer, any other type of computing device, or a combination thereof. It should be noted that, in some implementations, the server device 102 communicates with more or fewer devices than shown in FIG. 1A. While not illustrated, some communications may be transmitted through one or more networks (e.g., the Internet).

In operation the server device 102 establishes one or more asynchronous communication channels to facilitate communication between devices. An asynchronous communication channel is a communication channel in which participants need not be present simultaneously to participate. An example of an asynchronous communication channel is a chatroom. A first device associated with a first user may access the chatroom and transmit a message to the chatroom while a second device associated with a second user is not connected to the chatroom. The second device may access the chatroom at a later time and then receive and respond to the message. In contrast, a synchronous communication session (e.g., an audio and/or voice call) occurs in real time. Accordingly, a device not connected to a synchronous communication session may not receive and may be unable to respond to a message transmitted in the synchronous communication session. Establishing an asynchronous communication channel may include saving message data received from devices participating in the channel (e.g., in the memory 106), forwarding the message data to the devices participating in the channel, transmitting a graphical user interface based on the message data to the devices participating in the channel, or a combination thereof.

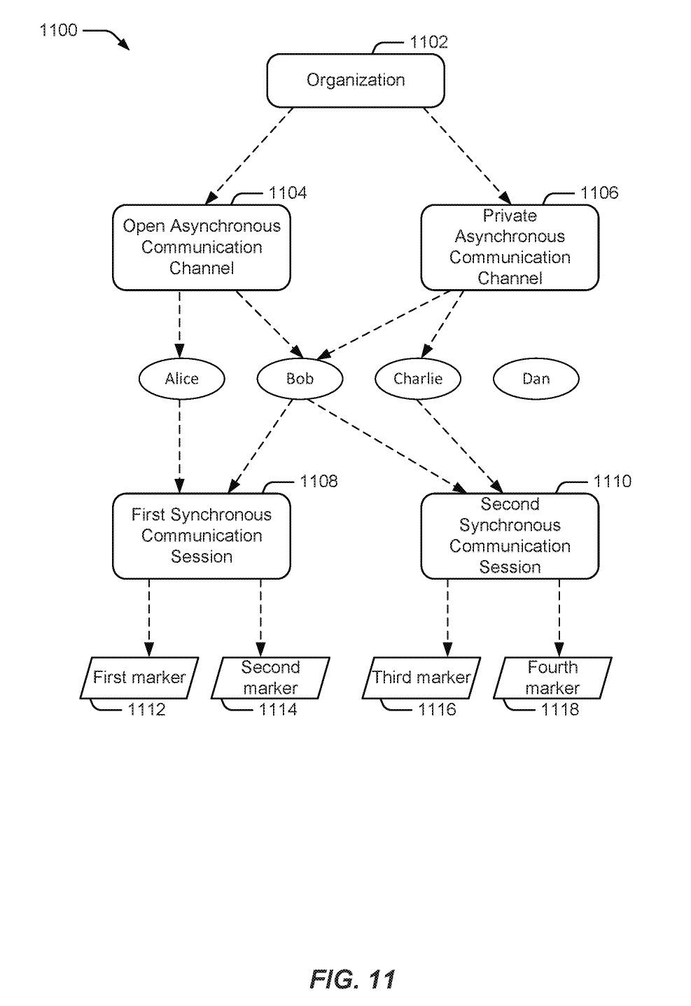

In the illustrated example of FIG. 1A, the server device 102 establishes an asynchronous communication channel 126 that is accessible to the first device 120, the second device 122, and the third device 124. Accessibility to the communication channel 126 may be determined as described below with reference to FIG. 11. While facilitating the asynchronous communication channel 126, the server device 102 receives, via the asynchronous communication channel 126, a request 130 to initiate a synchronous communication session 128 from the first device 120. For example, a user of the first device 120 may input “Launch synchronous app” into a chatroom that corresponds to the asynchronous communication channel 126. In response to the request 130, the server device 102 establishes the synchronous communication session 128 accessible to the devices 120, 122, and 124. For example, the server device 102 may create an audio and/or voice call and post an associated access link in the asynchronous communication channel 126. In the illustrated example, the first device 120 and the third device 124 join the synchronous communication session 128. Accordingly, users of the first device 120 and the third device 124 may communicate using the synchronous communication session 128.

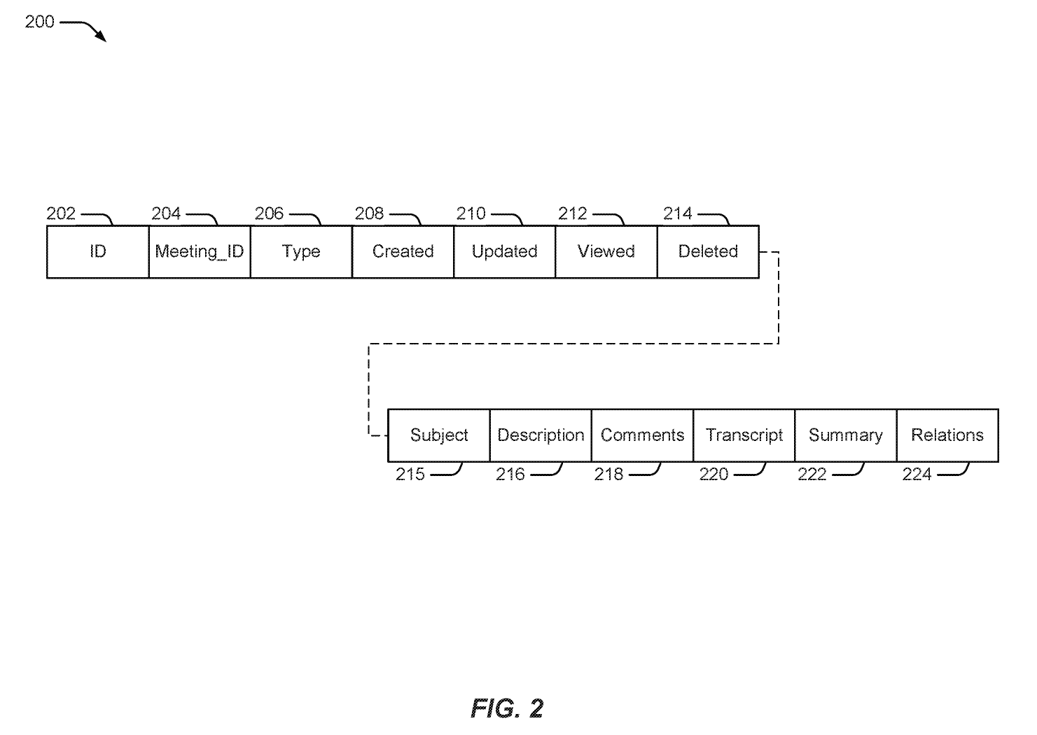

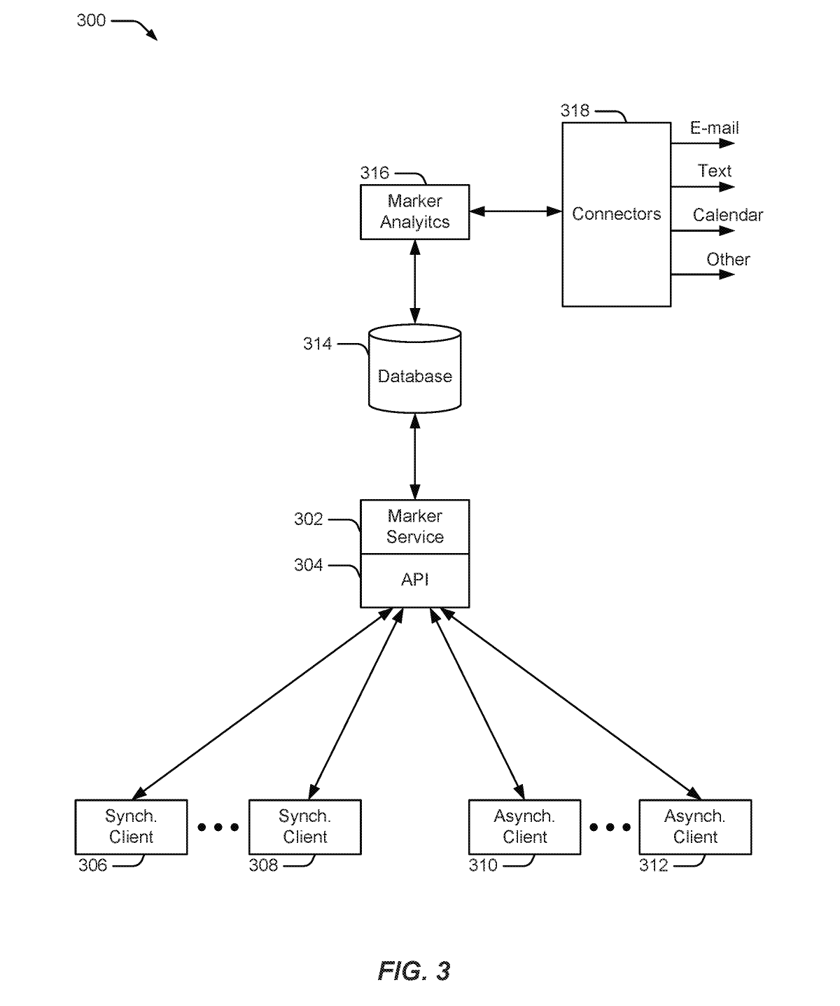

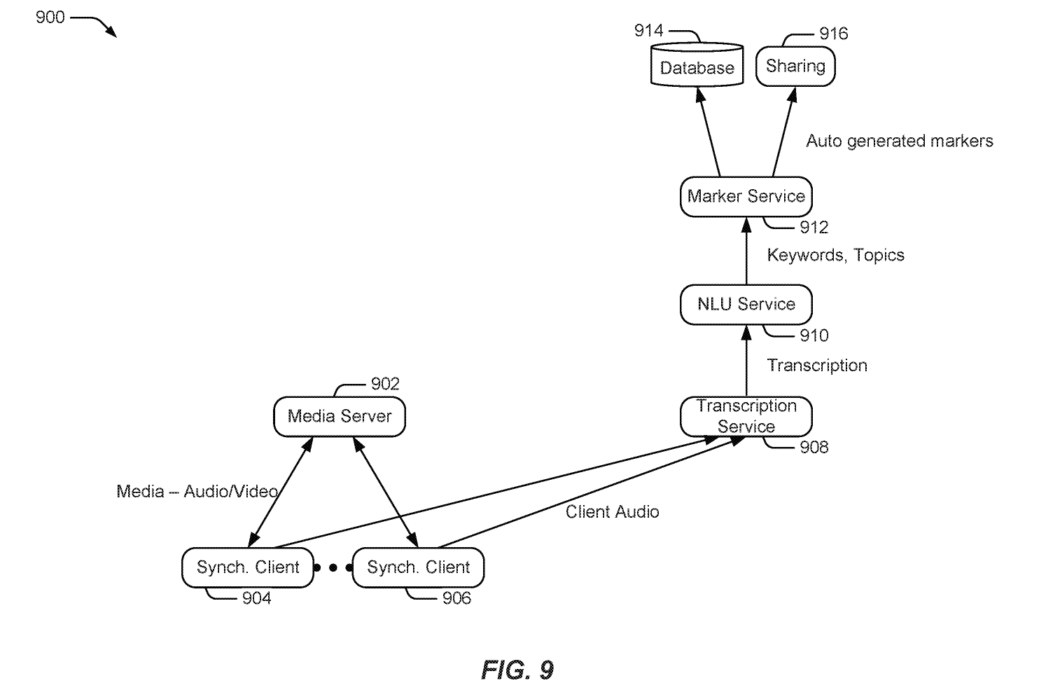

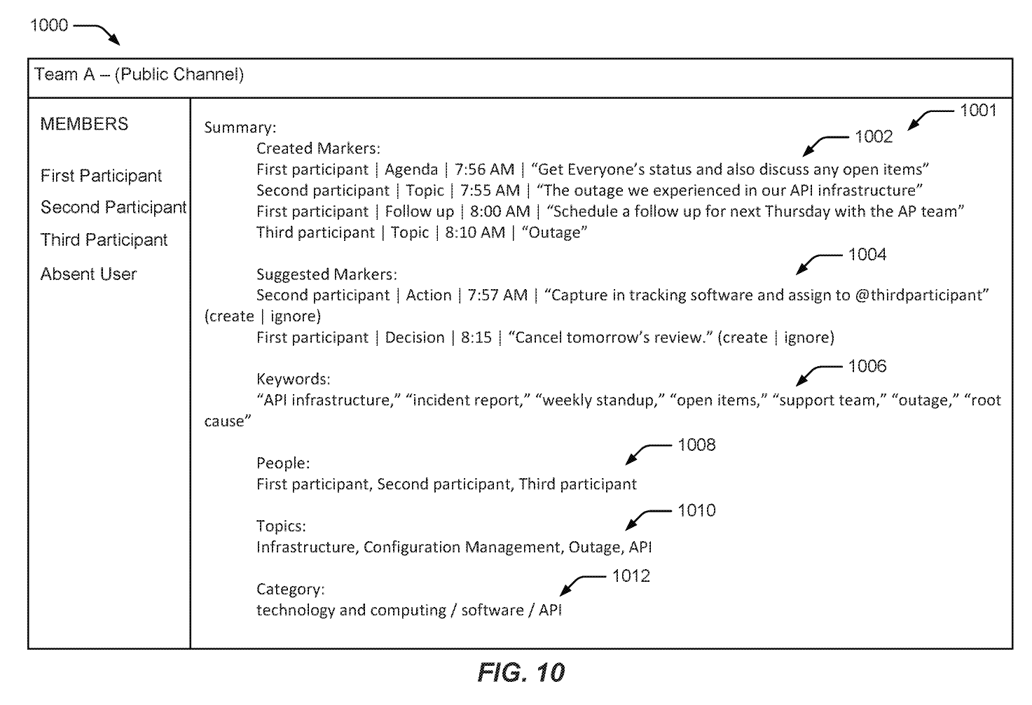

During the synchronous communication session 128, the server device 102 generates marker data 112 indicating a segment of the synchronous communication session 128. For example, the segment may correspond to a discussion of a particular topic that participants in the discussion may benefit from referring back to or that someone not participating in the discussion may wish or need to view. In some implementations, the marker data 112 indicates various metadata in addition to identifying the segment. Example fields of the marker data 112 are described further below, with reference to FIG. 2. In some implementations, the marker data 112 is generated based on user input, as described below with reference to FIGS. 3-8. In other examples, the marker data 112 is generated automatically, as described with reference to FIGS. 9-10. Further, during the synchronous communication session 128, the server device 102 stores segment data 114 in the memory 106. The segment data 114 corresponds to the segment indicated by the marker data 112. The segment data 114 includes, audio data, video data, content data, transcription data, analytics data, or a combination thereof associated with the segment. For example, the segment data 114 may correspond to an audio recording of the segment. In some implementations, the segment data 114 is stored in response to generation of the marker data 112 that indicates the segment. In other implementations, the segment data 114 is stored automatically. For example, the server device 102 may store data for each 15 second segment of the synchronous communication session 128.

The server device 102 outputs an indicator 132 identifying the marker data 112 to at least one of the devices 120, 122, 124 that can access the asynchronous communication channel 126. The indicator 132 may include the marker data 112 or a link to the marker data 112. In the illustrated example, the server device 102 outputs the indicator 132 to the asynchronous communication channel 126. Accordingly, one or more of the devices 120, 122, 124 may receive the indicator 132 via the asynchronous communication channel 126. In some examples, the server device 102 determines which devices and by what path to transmit the indicator 132 based on a type associated with the marker data 112. To illustrate, the marker data 114 may have a “personal” type. Accordingly, the indicator 132 may be sent privately to one of the devices 120, 122, 124 via the asynchronous communication channel 126 (e.g., via a whisper function of the asynchronous communication channel 126).

Devices that receive the indicator 132 generate a display based on the indicator 132. To illustrate, a device that receives the indicator 132 can access the marker data 112 to present (e.g., via graphical user interface) a link to the segment data 114 and/or text from one or more of the metadata fields of the marker data 112. In the illustrated example, in response to receiving the indicator 132 via the asynchronous communication channel 126, the first device 120 may display a link to the segment data 114 and/or text from one or more of the metadata fields of the marker data 112. Accordingly, a user of the first device 120 may access the segment data 114.

[41] In an example use case, the second device 122 the first device 120 and the third device 124 join the synchronous communication session 128. During the synchronous communication session 128, users of the first device 120 and the third device 124 discuss an issue that is relevant to a user of the second device 122. Accordingly, a user of the first device 120 causes the first device 120 to generate a marker request that is transmitted to the server device 102. In response to the marker request, the server device 102 generates the marker data 112 indicating the segment or segments of the synchronous communication session 128 that are associated with the issue. Further, in response to the marker request, the server device 102 transmits the indicator 132 via the asynchronous communication channel 126. After the indicator 132 is added to the asynchronous communication channel 126, the second device 122 accesses the asynchronous communication channel 126 and receives the indicator 132. The indicator 132 identifies the marker data 112. Accordingly, the second device 122 is able to use the indicator 132 to generate a display that includes values of one or more metadata fields of the marker data 112 and/or includes a link to the segment data 114. In some implementations, the second device 122 further presents via the display a link to join the synchronous communication session 128. Accordingly, the user of the second device 122 may use the indicator 132 to review metadata fields descriptive of the issue and/or the segment, access the segment data 114 to review the issue, join the synchronous communication session 128, or a combination thereof.

Thus, the system 100 enables reference and access to particular segments of a synchronous communication session using marker data generated during the synchronous communication session. Marking segments of the synchronous communication session enables calling out and cataloguing of important parts of discussions. Accordingly, these segments may be more easily accessed at a later time. Therefore, the disclosed systems and methods promote retention of information within an organization.

Referring to FIG. 1B, an alternative diagram of the system 100 for generating marker data is shown. As illustrated in FIG. 1B, rather than transmitting the indicator 132 of the marker data 112 via the asynchronous communication channel 126, the server device 102 may transmit the indicator 132 of the marker data 112 via an alternate path. Examples of alternate paths include short message service (SMS) messages, E-mail messages, instant messenger messages, etc. In the illustrated example of FIG. 1B, the server device 102 transmits the indicator 132 to the second device 122. In some implementations, which path (e.g., the asynchronous communication channel 126 or the alternate path) is used by the server device 102 to transmit the indicator 132 is based on a type of the marker data 112. For example, in response to determining that a type of the marker data 112 is “priority,” the server device 102 may transmit the indicator 132 via the alternate path. In some implementations, the server device 102 transmits the indicator 132 via both the alternate path and the asynchronous communication channel 126. The system 100 may operate both as described with reference to FIG. 1A and as described with reference to FIG. 1B. Accordingly, some indicators of marker data may be transmitted via the asynchronous communication channel 126 and some indicators of marker data may be transmitted via one or more alternate paths.

In an example use case, the second device 122 the first device 120 and the third device 124 join the synchronous communication session 128, but the second device 122 does not join the synchronous communication session 128 upon creation of the synchronous communication session. During the synchronous communication session 128, users of the first device 120 and the third device 124 discuss an issue that is relevant to a user of the second device 122. Accordingly, a user of the first device 120 causes the first device 120 to generate a marker request that is transmitted to the server device 102. In response to the marker request, the server device 102 generates the marker data 112 indicating the segment or segments of the synchronous communication session 128 that are associated with the issue and sets a type of the marker data 112 to “priority.” In response to the type of the marker data 112 corresponding to “priority,” the server device 102 transmits the indicator 132 to the second device 122 via an alternate path rather than (or in addition to) via the asynchronous communication channel 126. As described above, the second device 122 may use the indicator 132 to generate a display including values of one or more metadata fields of the marker data 112, a link to the segment data 114, a link to join the synchronous communication session 128, or a combination thereof. Accordingly, the user of the second device 122 may use the indicator 132 to view values of metadata fields that are descriptive of the issue and/or the segment, access the segment data 114 to review the issue, join the synchronous communication session 128, or a combination thereof.

Thus, the system 100 enables reference and access to particular segments of a synchronous communication session using marker data generated during the synchronous communication session. Marking segments of the synchronous communication session enables calling out and cataloguing of important parts of discussions. As illustrated in FIG. 1B, the system 100 is capable of transmitting an indicator identifying marker data via an alternate path to an individual who is not currently participating in the synchronous communication session. Accordingly, an important segment of the synchronous communication session may be called out to the individual in a timely fashion. Therefore, the disclosed systems and methods promote sharing and efficient distribution of information within an organization.

Referring to FIG. 2, a diagram 200 illustrating an example of metadata fields associated with a marker, such as a marker represented by the marker data 112, is shown. FIG. 2 illustrates an example in which the metadata fields of a marker include an identifier (ID) field 202, a meeting ID field 204 a type field 206 field, a created field 208, an updated field 210, a viewed field 212, a deleted field 214, a subject field 215, a description field 216, a comments field 218, a transcript field 220, a summary field 222, and a relations field 224. In some implementations, marker data includes different combinations of the illustrated fields 202-224 which may include one or more fields that are not illustrated in FIG. 2. The fields 202-224 are described below.

The ID field 202 stores a unique identifier for the marker. In some examples, the unique identifier corresponds to a globally unique identifier. The unique identifier may be used by a storage system, such as a database included in the memory 106, to index the marker. For example, the identifier may be a key to a row that corresponds to the marker in a marker database.

The meeting_ID field 204 stores an identifier associated with the synchronous communication session the marker is associated with. In the example of FIG. 1, the meeting_ID field 204 of the marker data 112 stores an ID identifying the synchronous communication session 128. Media content storage systems may store media content associated with a synchronous communication session (e.g., audio content, video content, text transcript content) indexed by the ID of the synchronous communication session. Thus, a value of the meeting_ID field 204 may be used to access media data (e.g., the segment data 114) in a memory device (e.g., the memory 106). Further, as described below, a marker search system may determine access criteria associated with the marker based on access criteria of the associated synchronous communication session. Accordingly, the marker search system may use a value of the meeting_ID 204 to determine the access criteria associated with the marker.

The type field 206 stores a value indicating a type of the marker. Examples of marker types include “Topic,” “Action,” “Decision,” “FYI,” “Agenda,” “Priority,” “Personal,” “Follow-up,” and custom types. The type labels described herein (e.g., “Topic,” etc.) are provided as an example and not meant to be limiting. The “Topic” type indicates that a segment indicated by the marker corresponds to a portion of a synchronous communication session setting a new topic of discussion. For example, a topic type marker may indicate a segment corresponding to two users beginning to discuss an increase in interest rates.

The “Action” type indicates that a segment is related to an action item assigned to one or more users. As described below, the description field 216, described further below, may identify may identify the user and the action. For example, an action type marker may indicate a segment discussing a memory leak in a product and who should resolve it. The description field 216 may indicate who should resolve the memory leak and/or how.

The “Decision” type indicates that a segment includes a decision made during a synchronous communication session. For example, a decision type marker may indicate a segment during which a budget is approved. In some implementations, the description field 216 summarizes the decision.

The “FYI” type indicates that a segment might be of interest to one or more users. The description field 216 may identify the user(s).

The “Agenda” type indicates that a segment includes discussion of an agenda for a synchronous communication session.

The “Priority” type indicates that one or more absent users should participate in an ongoing discussion during the synchronous communication session. The “Priority” type is associated with special routing rules. As explained above, a marker service system, such as the server device 102, may distribute an indicator associated with a priority type marker to one or more devices associated with the absent user(s) via an asynchronous communication channel and/or an alternate path (e.g., SMS, e-mail, etc.) The description field 216 of a priority type marker may include an invitation (e.g., a message and or a link) to join the synchronous communication session. Accordingly, an absent user who receives the indicator of the priority type marker may access data (e.g., audio, video, transcript, etc.) associated with the segment indicated by the marker to learn the details of the discussion and then join the synchronous communication session to participate.

The “Personal” type indicates a user's personal notes. For example, the user may set a personal type marker to identify a segment of a synchronous communication session to review at a later time. Personal type markers may have distinct routing rules. For example, a personal type marker may be transmitted only to devices associated with the user who requested the personal type marker.

The “Follow-up” type indicates a segment corresponding to a discussion that of an issue that requires a check at a later time. For example, a follow-up type marker may correspond to a discussion of project goals for a particular date.

Marker types may be user-defined. That is, a marker service system, such as the server device 102, may support creation of custom marker types. Routing rules for custom markers may be user-defined as well. In particular, custom markers may be associated with output to particular applications. For example, a custom “workflow” type may be associated with output to a workflow management application. Synchronization of marker data with other applications is described further below with reference to FIG. 3.

In addition to affecting how a marker service routes an indicator, marker type may influence how a device generates a display based on the indicator. For example, the device may display an icon associated with the type.

Referring back to the fields 202-224 of the marker illustrated in FIG. 2, the created field 208 stores a user_ID value and a time value. The user_ID value corresponds to a unique identifier of a user who requested creation of the marker. In cases where the marker is automatically generated, the user_ID value may identify a device or system. In some examples, automatically generated markers include a value of “0” for the user_ID value. The time value indicates a time of creation of the marker. The time value may indicate a time relative to a start of the synchronous communication session associated with the marker. Alternatively, the time value may indicate a time according to an international time standard (e.g., coordinated universal time).

The updated field 210 stores a list of user_ID value, time value pairs. Each entry in the list corresponds to an update applied to the marker. The user_ID value of an entry identifies a user or system (as explained above) who initiated the corresponding update to the marker. The time value of the entry identifies when (as explained above) the update was entered. The updated field 210 may be empty (e.g., store a “0” or null in cases where the marker has not been updated.

The viewed field 210 stores a list of user_ID value, time value pairs. Each entry in the list of the viewed field 210 corresponds to an instance of a user accessing data (e.g., viewing video) associated with the segment identified by the marker. The viewed field 210 may be empty.

The deleted field 212 stores a user_ID value and a time value. The user_ID value of the deleted field 212 indicates the user or system (as explained above) who deleted the marker. The time value indicates when (as explained above) the user deleted the marker. The deleted field 212 may be empty (e.g., if the marker has not been deleted).

The subject field 215 stores a text string identifying a subject of the marker. The text string may identify one or more users associated with the marker and/or include a short description of the marker. An example text string included in the subject field 215 of an action type marker is “Check on the memory leak @alice.” A synchronous communication session segment identified by the example action type marker may include a discussion of the memory leak. The subject field 215 may be empty.

The description field 216 stores a text string identifying a more detailed description of the subject of the marker. The text string may identify one or more users associated with the marker and/or include a short description of the marker. An example text string included in the description field 216 of the example action type marker is “Alice, please ensure you run the instrumentation checks at peak load.” A synchronous communication session segment identified by the example action type marker may include a discussion of the memory leak. Thus, the text string of the description field 216 may elaborate on the text string of the subject field 215. The description field 216 may be empty.

The comments field 218 stores a list of sets, where each set includes a user ID value, a time value, and a text string. Each set corresponds to a comment related to the comment. The user ID value identifies who made the comment, the time value identifies when the comment was made, and the text string includes the text of the comment. The comment field 218 may be updated by a marker service (e.g., the server device 102) based on comment data received from one or more devices (e.g., the devices 120-124).

The transcript field 220 stores a transcript string corresponding to a transcript of a first duration of the synchronous communication session prior to creation of the marker and/or a second duration of the synchronous communication session after to creation of the marker. The segment identified by the marker may correspond to the first duration and/or the second duration. In an illustrative example of the transcript field 220, the marker may be created at minute 5 of the synchronous communication session, and the transcript field 220 may store a text transcript of discussions that occurred at minutes 3-5 and/or 5-7. The segment identified by the marker may correspond to the all or a portion of minutes 3-7 of the synchronous communication session. In some embodiments, a device that receives an indicator of the marker (e.g., the indicator 132) may display the transcript string of the transcript field 220 to a user. Accordingly, the user may ascertain a context and/or content of the segment identified by the marker. The transcript field 220 may be empty.

The summary field 222 stores a summary of the segment identified by the marker. The summary includes a list of keywords, people, and topics. The list of keywords includes a list of keyword tags indicated by the creator of the marker and/or a list of keywords recognized by the marker service (e.g., the server device 102) in the transcript string of the transcript field 220. The list of people identifies users participating in (e.g., logged into, speaking during, etc.) the synchronous communication session during the segment. The list of topics identifies a list of topics discussed during the segment. The list of people and the list of topics may be user generated or automatically generated by the marker service.

The relations field 224 stores a list of marker_ID, relation identifier pairs. Each element of the list in the relations field 224 identifies a relation between the marker and another marker (of the same or different synchronous communication sessions). The marker_ID in the list identifies another marker that the marker is related to, and the relation identifier indicates what type of relation exists between the two markers. The relation may be user-defined or derived by the marker service. An example relation is “similar to.” To illustrate, a marker service may determine that a first marker is similar to a second marker when summary fields of the first marker and the second marker identify common keywords (e.g., more than a threshold number of). A device that receives the indicator (e.g., the indicator 132) of the marker (e.g., the marker data 112) may display the value(s) of the relations field 224 to a user. Accordingly, the user may be able to access segments of one or more synchronous communication sessions that are relevant to the user.

Thus, FIG. 2 illustrates examples of fields that may be included in a marker. The fields may include values that facilitate sharing and access to information shared during a synchronous communication session. Accordingly, information shared in a synchronous communication session may be more easily maintained and used in an organization as compared to a case where the synchronous communication session is stored, accessed, and shared in its entirety.

Referring to FIG. 3, a logical representation of a system 300 for generating and distributing markers is shown. Elements of the system 300 may be implemented by various hardware devices, such as the elements of the system 100.

The system 300 includes a marker analytics module 316, connector modules 318, a database 314, a marker service 302, an application programming interface (API) 304, a first synchronous client 306, a second synchronous client 308, a first asynchronous client 310, and a second asynchronous client 312.

In some implementations, the marker analytics module 316, the connector modules 318, the database 314, the marker service 302, the application programming interface 304 are implemented by a single device, such as the server device 102. In other implementations of the system 300, the marker analytics module 316, the connector modules 318, the database 314, the marker service 302, the application programming interface 304 are implemented by any combination of hardware devices. For example, the marker service 302 and the API 304 may be implemented by a single device while the database 314 is implemented on another, and the marker analytics module 316 and the connectors 318 are implemented on still another device. While FIG. 1, illustrates the server device 102 providing the asynchronous communication channel 126 and generating the marker data 112, the marker service 302 may be provided on a device distinct from a device that provides an asynchronous communication channel (or a synchronous communication session). In some implementations of the system 300, the first synchronous client 306 and the first asynchronous client 310 correspond to software executed on a single device (e.g., the first device 120). Similarly, the second synchronous client 308 and the second synchronous client 312 correspond to software executed on another device (e.g., the third device 124).

The marker analytics module 316 is configured to access marker data stored in the database 314 and to generate various analytics related to the marker data. Generating the analytics may include identifying common topics, common keywords, relationships between markers, relationships between markers and applications, relationships between markers and users, etc. Based on the generated analytics, the marker analytics module 316 is further configured to cause the connector modules 318 to synchronize one or more applications with the marker data. The connector modules 318 may correspond to APIs associated with various applications. Synchronizing marker data with one or more application may include transmitting a message via the one or more applications, creating data associated with the marker data in the one or more applications, etc. The marker service 302 may select an enterprise application to update based on a particular marker according to a type of the particular marker. In one example, the marker analytics module 316 is configured to transmit priority type marker data to a device by E-mail or SMS via the connector modules 318. As another example, the marker analytics module 316 may access the connector modules 318 to add an entry corresponding to an action type marker to a calendar application or workflow management application.

The marker data stored in the database 314 is generated by the marker service 302 based on messages received from the clients 306-312 via the API 304. The marker service 302 is further configured to access the database 314 to search for marker data based on search requests received from the clients 306-312. In addition, the marker service 302 is configured to return marker data to the clients 306-312 in response to search requests or in response to marker generation.

[75] The asynchronous clients 310, 312 correspond to software configured to enable a user to access and communicate via an asynchronous communication channel (e.g., the asynchronous communication channel 126). In embodiments in which the marker service 302 is provided by a separate device than the asynchronous communication device, the asynchronous clients 310, 312 include instructions (e.g., a plug-in module) enabling the asynchronous clients 310, 312 to send and receive messages related to markers to the marker service 302 via the API 304. In embodiments in which the marker service 302 is provided by the same device as the asynchronous communication channel, the API 304 is configured to process messages received in the asynchronous communication channel.

Similarly, the synchronous clients 306, 308 correspond to software configured to enable a user to access and communicate via a synchronous communication session (e.g., the synchronous communication session 128). In embodiments in which the marker service 302 is provided by a separate device than the synchronous communication session, the synchronous clients 306, 308 include instructions (e.g., a plug-in module) enabling the synchronous clients 306, 308 to send and receive messages related to markers to the marker service 302 via the API 304. In embodiments in which the marker service 302 is provided by the same device as the synchronous communication session, the API 304 is configured to process messages received as part of the synchronous communication session. In some implementations, the API 304 is exposed to the clients 306-312 as a representational state transfer (RESTful) service over http.

In operation, the first asynchronous client 310 and the second asynchronous client 312 access and interact with an asynchronous communication channel (e.g., the asynchronous communication channel 126). The asynchronous clients 310, 312 receive indicators of markers from the marker service 302 via the API 304 and generate displays indicating the markers. For example, the asynchronous clients 310, 312 may correspond to chatroom clients that display information regarding marker data within a chatroom dialog box. As explained above, an asynchronous client may receive an indicator of marker data in response to generation of the marker or in response to a search request. The asynchronous clients 310, 312 enable users to initiate such search requests. For example, a user of the first asynchronous client may input a search request into the chat dialog box as “/markersearch memory leak.” In response to the input, the first asynchronous client 310 transmits the search request to the marker service 302 via the API 304, and the marker service 302 accesses the database 314 to find markers related to “memory leak.” Search results returned to the first asynchronous client 310 by the marker service 302 may be based on marker access criteria as described further below.

[78] The asynchronous clients 310, 312 further enable access to segments identified by marker data. For example, in response to a user selecting a link identified by a marker, the first asynchronous client 310 may initiate retrieval (e.g., from the marker service 302 or another device) and presentation (e.g., via the first synchronous client 306 or another device) of media data associated with the segment indicated by the marker.

The asynchronous clients 310, 312 further enable users to comment on or delete marker data stored in the database 314. For example, responsive to user input, the first asynchronous client 310 may transmit to the marker service 302 comment data associated with particular marker data. Accordingly, the marker service 302 may update the comments field 218 of the particular marker data stored in the database 314. The marker service 302 may further add a discussion thread associated with the particular marker to the asynchronous communication channel. Each reply to the discussion thread may be added by the marker service 302 to the comments field 218.

As another example, responsive to user input, the first asynchronous client 310 may transmit to the marker service 302 a deletion request associated with particular marker data. Accordingly, the marker service 302 may update the deleted field 214 of the particular marker data. The marker service 302 may be configured to not send deleted marker data to clients associated with users that lack administrative privileges.

In operation, the first synchronous client 306 and the second synchronous client 308 access and interact with a synchronous communication session (e.g., the synchronous communication session 128). The synchronous clients 306, 308 receive indicators of markers from the marker service 302 via the API 304 and generate displays indicating the markers. For example, the synchronous clients 306, 308 may correspond to video conference clients that display information regarding marker data within a progress bar or other GUI element. An asynchronous client may receive an indicator of marker data in response to generation of the marker or in response to a search request. The synchronous clients 306, 308 are configured to support marker generation. For example, responsive to user input during a synchronous communication session, the first synchronous client 306 may send to the marker service 302 a request (e.g., the request 130) to create a marker. In response to the request, the marker service 302 generates marker data and adds the marker data to the database 314. The marker service 302 automatically generates a unique identifier to populate the ID field 202 of the marker data. Further, the marker service 302 populates the meeting_ID field 204 of the marker data based on a meeting_ID of the synchronous communication session. The marker service 302 populates the type field 206, the subject field 215, and the description field 216 based on the input received from the content of the request. In some implementations, the request further includes information for the marker service 302 to populate the transcript field 220.

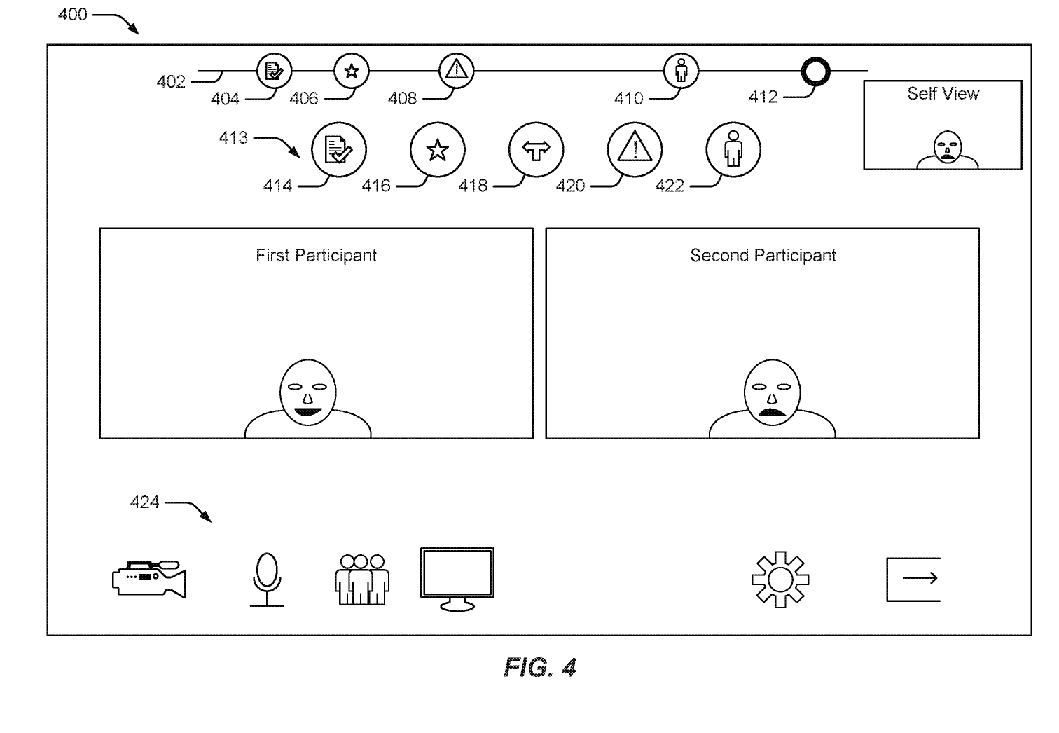

As described with reference to the asynchronous clients 310, 312, the synchronous clients 306, 308 may support searching for markers, commenting on markers, and deletion of markers. FIGS. 4-7 illustrate examples of interfaces provided by the clients 306-312.

As described above, the system 300 supports creation of and access to markers identifying segments of a synchronous communication session. Accordingly, information exchanged in the synchronous communication session may be more easily accessed at a later time by users who did and did not participate. Thus, distinctions between synchronous and asynchronous communication may be blurred and information may be more easily retained and accessed within an organization.

FIG. 4 illustrates a screen 400 of a GUI generated by a synchronous client during a synchronous communication session. The screen 400 may be generated by one of the synchronous clients 306, 308 of FIG. 3 and/or by one of the devices 120-124 of FIG. 1. The screen 400 includes a progress bar 402. The progress bar 402 corresponds to a timeline representing the synchronous communication session. The progress bar 402 includes a first symbol 404 indicating that topic type marker was created at (and corresponds to) a first time in the synchronous communication session. The progress bar 402 includes a second symbol 406 indicating that an action type marker was created at (and corresponds to) a second time in the synchronous communication session. The progress bar 402 includes a third symbol 408 indicating that a priority type marker was created at (and corresponds to) a third time in the synchronous communication session. The progress bar 402 includes a fourth symbol 410 indicating that a personal type marker was created at (and corresponds to) a fourth time in the synchronous communication session. The progress bar 402 includes a fifth symbol 412 identifying a current time in the synchronous communication session. Accordingly, a user may view indicators of markers associated with a synchronous communication session during the synchronous communication session.

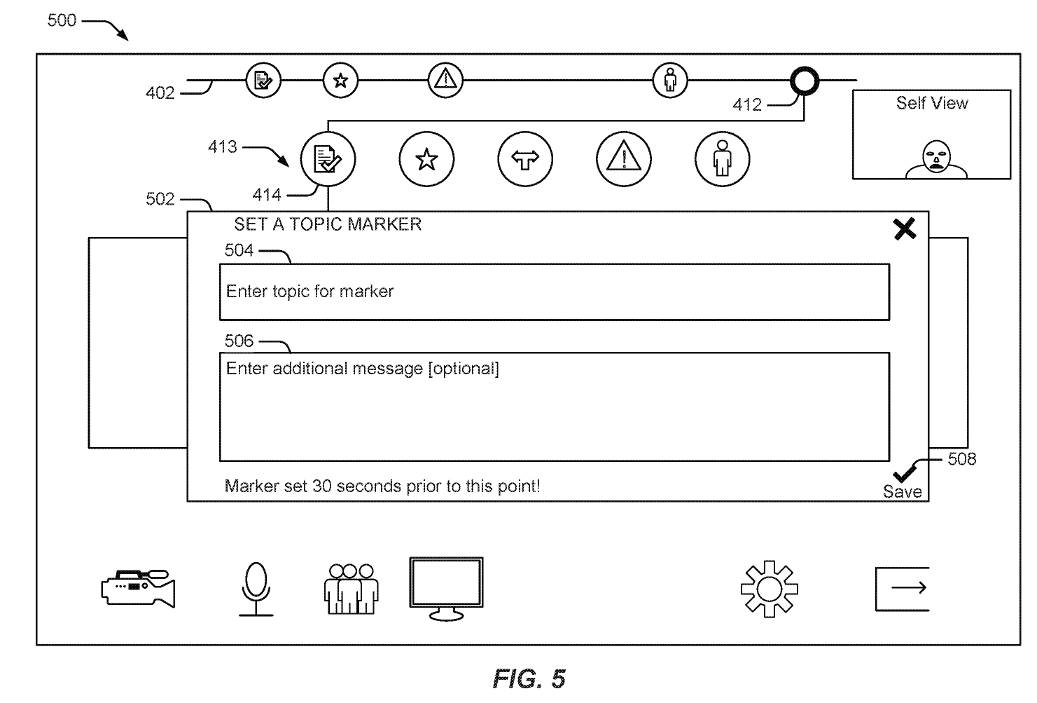

The screen 400 further includes marker creation buttons 413. The marker creation buttons 413 include a topic button 414, an action button 416, a decision button 418, a priority button 420, and a personal button 422. Each of the marker creation buttons 413 is associated with creating a corresponding type of marker identifying a segment of the synchronous communication session associated with the current time indicated by the fifth symbol 412, as described below with reference to FIG. 5. In some examples, the marker is to be set at a prior point in time that is a fixed amount of time (e.g., 30 seconds) before the current time indicated by the fifth symbol 412. Accordingly, the marker may identify a segment that includes the prior point in time and/or the current time. In some implementations, the screen 400 includes an option to create a custom marker type and to link the custom marker type to a particular enterprise application.

The screen 400 further includes control buttons 424 that control functionality of the synchronous communication session. For example, one button controls whether a camera is activated, another controls whether a microphone is muted, etc.

Referring to FIG. 5, a second screen 500 of the GUI generated by the synchronous client during the synchronous communication session is shown. The second screen 500 is displayed in response to user selection of the topic button 414. The second screen 500 includes a dialogue box 502. The dialogue box 502 includes a first text field 504, a second text field 506, and a save button 508. In response to user selection of the save button 508, the synchronous client (e.g., one of the synchronous clients 306, 308) generates a request (e.g., the request 130) and transmits the request to a marker service (e.g., the marker service 302). The request indicates a user ID associated with a user of the synchronous communication client, a meeting ID associated with the synchronous communication session, a time (the current time indicated by the fifth symbol 412 or the prior point in time described above), a marker type (determined based on which of the marker creation buttons was selected), content of the first text field 504, content of the second text field 506, transcript data, or a combination thereof. In response to the request, the marker service generates new marker data (e.g., the marker data 112) and transmits an indicator of the marker data to one or more devices. The marker service uses the request to populate fields of the marker data. For example, the marker service may set the meeting ID field 204 based on the meeting ID indicated by the request. The marker service may set the type field 206 based on the marker type indicated by the request. The marker service may set the created field 208 based on the user ID and the time indicated by the request. The marker service may set the subject field 215 based on the content of the first text field 504, and the marker service may set the description field 216 based on the content of the second text field 506. Thus, FIGS. 4 and 5 illustrate screens displayed by a synchronous client and usable by a user to create markers.

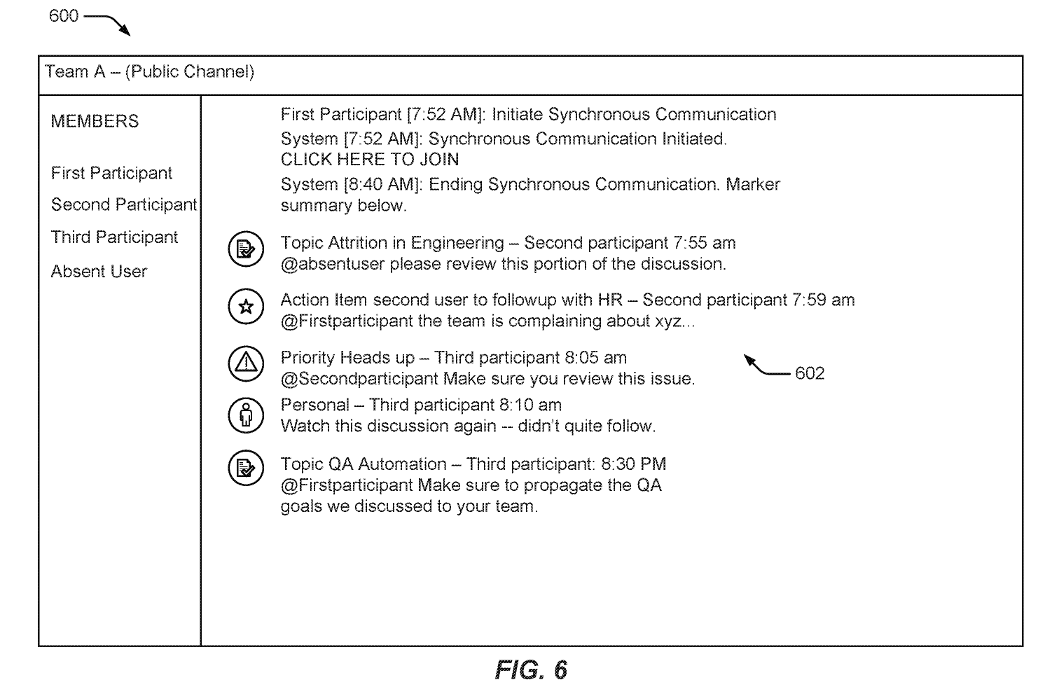

Referring to FIG. 6, a screen 600 of a GUI generated by an asynchronous client is shown. The asynchronous client may correspond to one of the asynchronous clients 310, 312. The screen 600 includes elements 602 identifying a plurality of markers generating during the synchronous communication session described with reference to FIGS. 4-5. The elements 602 may be generated based on one or more indicators (e.g., the indicator 132) received from the marker service upon completion of the synchronous communication session. The elements 602 identify each of the markers created during the synchronous communication session described with reference to FIGS. 4-5. In alternative examples, the elements 602 may correspond to search results received from the marker service in response to a search request.

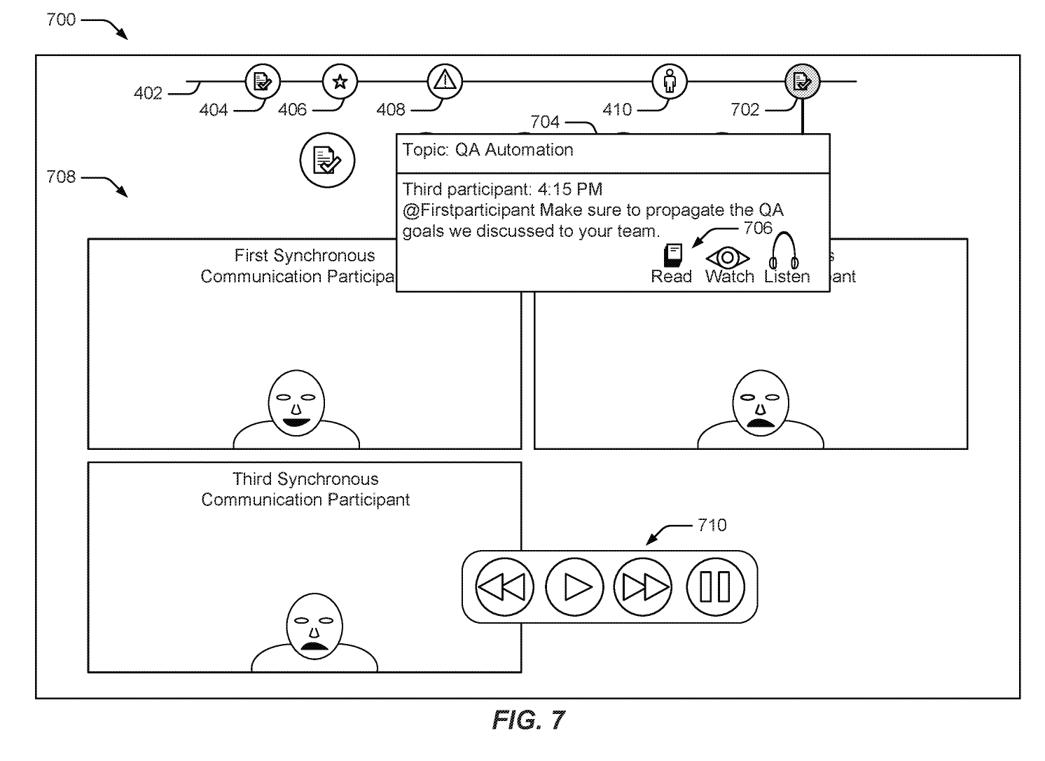

User selection of one of the elements 602 corresponding to a particular marker prompts the asynchronous client to launch a synchronous client (e.g., one of the synchronous clients 306 308) and to send a request for data (e.g., media data) associated with the particular marker to the marker service. FIG. 7 illustrates a third screen 700 the GUI of the synchronous communication client generated in response to user selection of one of the elements 602 that corresponds to the marker created by the marker service in response to selection of the save button 508.

As illustrated, the third screen 700 includes the progress bar 402 displaying the first symbol 404, the second symbol 406, the third symbol 408, the fourth symbol 410, and a sixth symbol 702. The sixth symbol 702 corresponds to the marker created by the marker service in response to selection of the save button 508. The third screen 700 further includes an information box 704. The information box 704 displays information (e.g., contents of the subject field 215 and the description field 216) related to a selected marker. In the example, the marker corresponding to the sixth symbol 702 is selected. The information box 704 further includes selectable options 706 that include an option to read a transcript, an option to watch, and an option to listen to a segment of the synchronous communication session that corresponds to the selected marker. The synchronous client may retrieve media data (e.g., audio data, video data, and or transcript data) associated with the selected marker from the marker service or from a separate media storage system. Accordingly, in response to selection of the read a transcript option, the GUI of the synchronous client may display a transcript of the segment associated with the selected marker. Similarly, in response to selection of the watch option, the GUI may present video playback of the segment, and in response to selection of the listen option, the GUI may present audio only playback of the segment associated with the selected marker.

The third screen 700 further includes playback 708 of the synchronous communication session (e.g., displayed in response to selection of the watch option). The playback 708 is set to a point in time that corresponds to the marker associated with the selected sixth symbol 702. In response to selection of one of the other symbols 404-410, the synchronous client is configured to update the progress bar 402, the information box 704, and the playback 708 accordingly.

The synchronous client further includes navigation controls 710 configured to control the playback 708 of the synchronous communication session.

Thus, FIG. 7 illustrates how a user may access a particular segment of a recorded synchronous communication session using marker data. Accordingly, particular information included in the recording may be more easily accessed and distributed.

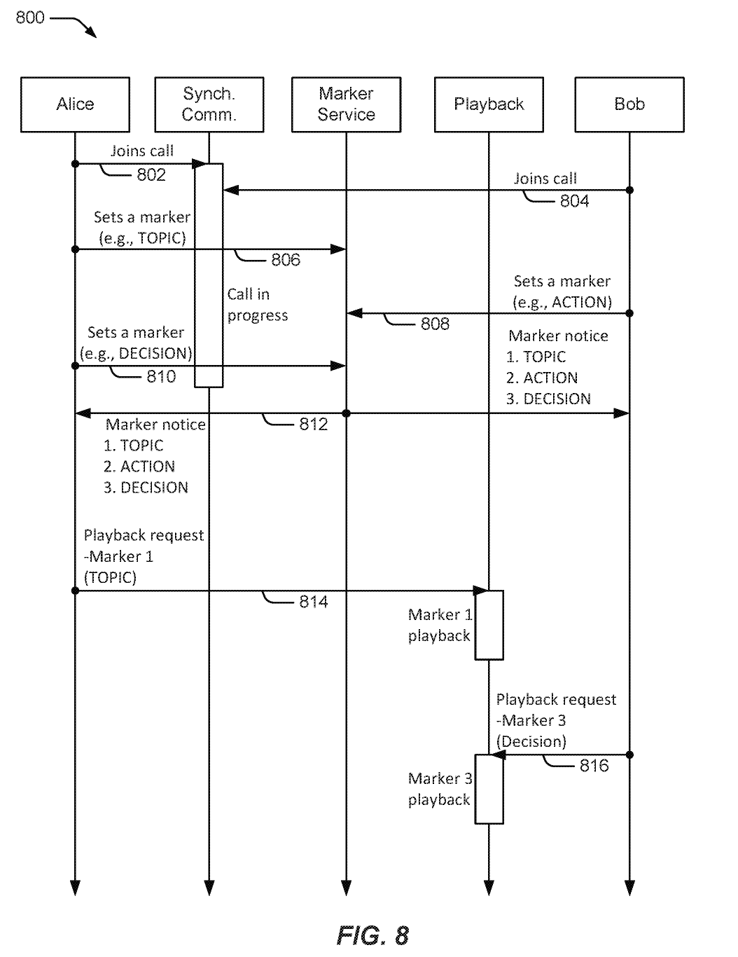

Referring to FIG. 8, a sequence diagram 800 illustrating an example of process of creating and using markers is shown. In the sequence diagram 800 a user named Alice joins a synchronous communication session, at 802. The synchronous communication session may correspond to the synchronous communication session 128. Alice may be a user of one of the devices 120-124 operating one of the synchronous clients 306, 308.

A user named Bob joins the synchronous communication session, at 804. Bob may be a user of one of the devices 120-124 operating one of the synchronous clients 306, 308. Alice and Bob begin to have a discussion as part of the synchronous communication session. During the discussion Alice and Bob begin to discuss a new topic, such as a software release. Alice sets a topic marker associated with a segment of the communication session in which Bob and Alice begin to discuss the software release by causing her synchronous client to send a request to a marker service, at 806. For example, Alice may use the screens 400, 500 on her synchronous client to request the first marker be created.

While discussing the software release, Alice and Bob agree than Jan should run a debug program to identify a source of a memory leak. Accordingly, Bob sets an action marker associated with a segment of the synchronous communication session in which Bob and Alice discuss Jan running the debug software by causing his synchronous client to send a request to the marker service, at 808. For example, Bob may use the screens 400, 500 on his synchronous client to request the second marker be created.

After assigning debug testing to Jan, Alice and Bob agree than Jan should run the debug program, Alice and Bob decide to schedule product release for next fall. Accordingly, Alice sets a decision marker associated with a segment of the synchronous communication session in which Alice and Bob agree to release the software in the fall by causing her synchronous client to send a request to the marker service, at 810.

After the synchronous communication session ends, the marker service pushes indications of the markers to an asynchronous communication channel, at 812. The asynchronous communication channel is accessible to asynchronous clients associated with Alice and Bob (e.g., the asynchronous clients 310-312). Accordingly, Alice and Bob's asynchronous clients may display the markers using the screen illustrated in FIG. 6. Jan may also have access to the asynchronous communication channel.

Later Alice may wish to view the discussion of the product release. Accordingly, she may select the topic marker associated with the product release in her asynchronous client, and her asynchronous client may request playback of the segment associated with the topic marker, at 814. Requesting playback of the segment may include launching Alice's synchronous client and causing Alice's synchronous client to request playback of the segment from a playback service.

Later Bob may forget when the product release is scheduled for. Accordingly, he may select the decision marker associated with the decision to release in the fall in his asynchronous client, and his asynchronous client may request playback of the segment associated with the decision marker, at 816. Requesting playback of the segment may include launching Bob's synchronous client and causing Bob's synchronous client to request playback of the segment from the playback service. While illustrated as distinct services, the playback service, the marker service, the synchronous communication service, or a combination thereof may be provided by a single device.

Thus, the sequence diagram 800 illustrates how markers may be created and distributed. Further the sequence diagram 800 illustrates how markers may be used to conveniently refer to and access a segment of a synchronous communication session.

Referring to FIG. 9, a logical representation of a system 900 for automatically generating and distributing markers is shown. Elements of the system 900 may be implemented by various hardware devices, such as the elements of the system 100.

The system 900 includes a media server 902, a first synchronous client 904, a second synchronous client 906, a transcription service 908, a natural language understanding (NLU) service 910, a marker service 912, a database 914, and a sharing platform 916.

In operation the media server 902 supports a synchronous communication session between the synchronous clients 904, 906. During the synchronous communication session, the synchronous clients 904, 906 transmit audio data to the transcription service 908. The audio data corresponds to human speech captured by the synchronous clients 904, 906. The transcription service 908 generates a transcription of the audio data received from the synchronous clients 904, 906 and transmits the transcription to the NLU service 910. The NLU service 910 processes the transcription to identify keywords and/or topics discussed during the synchronous communication session. The NLU service 910 transmits the identified keywords and/or topics and corresponding timestamps to the marker service 912. The marker service 912 automatically generates marker data based on the identified keywords and/or topics and the corresponding timestamps. For example, the marker service 912 may generate a topic marker in response to a “topic” keyword.

The marker service 912 stores the auto generated markers in the database 914 and distributes the auto generated markers via the sharing platform 916. For example, the auto generated markers may be transmitted to one or more asynchronous clients via the sharing platform 916 or to a device via SMS message, E-mail, etc. In some implementations, the marker service 912 transmits a query identifying the auto generated markers to a device associated with a system administrator prior to distributing the auto generated markers via the sharing platform 916. In response to a message from the administrator canceling a marker, the marker is deleted and is not distributed. In response to a message from the administrator confirming a marker, the marker is distributed via the sharing platform 916. In other implementations the marker service 912 shares all auto generated markers via the sharing platform 916. A portion of the auto generated markers may be classified as suggested markers.

Thus, FIG. 9 illustrates how a system may automatically generate and distribute markers. It should be noted that the elements of the system may be combined to form a system that supports auto generated markers and manually created markers.

Referring to FIG. 10, a screen of a GUI generated by an asynchronous client and displaying auto generated markers is shown. The screen 1000 is presented in response to data received via the sharing platform 916. As illustrated, the screen 1000 includes a summary 1001 of a synchronous communication session. The summary 1001 includes markers 1002 created generated by the marker service 912. The markers 1002 may correspond to automatically generated markers or user generated markers as described with reference to FIG. 3.

The summary 1001 further includes suggested markers 1004. As illustrated, each of the suggested markers 1004 includes a create option and an ignore option. Accordingly a user may interact with the GUI to accept or reject suggested markers. In response to user input to create a particular suggested marker, the asynchronous client transmits a create message to the marker service 912. In response to the create message, the marker service 912 saves the particular suggested marker as a marker in the database 914. In response to user input to ignore a particular suggested marker, the asynchronous client transmits an ignore message to the marker service 912. In response to the ignore message, the marker service 912 deletes the particular suggested marker from the database 914.

The summary 1001 further includes keywords 1006 identified by the NLU service 910 as being spoken during the synchronous communication session. The summary 1001 further identifies people 1008 who participated in the synchronous communication session and topics 1010 identified by the NLU service 910 as being discussed during the synchronous communication session. The summary 1001 further identifies a category 1012 of the synchronous communication session. The category 1012 may be determined by the marker service 912 based on the keywords 1006, the people 1008, the topics 1010, or a combination thereof.

The markers 1002 and the suggested markers 1004 may be selected to launch a synchronous client as described with reference to FIGS. 6 and 7. Thus, FIG. 10 illustrates a screen of a GUI that may be presented to a user so that the user may access one or more segments of a synchronous communication session. Accordingly, information in synchronous communication sessions may be more easily accessed and referred to.

Referring to FIG. 11, a diagram 1100 illustrating relationships between elements of an organization are shown. The relationships may be used by marker service to determine access criteria for markers (e.g., in the context of a marker search request). The diagram 1100 illustrates an organization 1102. The organization 1102 may correspond to a business or other entity. The organization 1102 is associated with an open asynchronous communication channel 1104 and a private asynchronous communication channel 1106. The asynchronous communication channels 1104, 1106 may correspond to chatrooms associated with different teams within the organization 1102. The open asynchronous communication channel 1104 has members Alice and Bob. However, the open asynchronous communication channel 1104 has “open” access criteria. That is, any member of the organization 1102 may access the open asynchronous communication channel 1104. The private asynchronous communication channel 1106 has members Bob and Charlie, and has access criteria that restricts access to members only. Dan is not a member of the organization 1102.

Alice or Bob launches a first synchronous communication session 1108 from the open asynchronous communication channel 1104, and during the first synchronous communication session 1108, a first marker 1112 and a second marker 1114 are created. The first synchronous communication session 1108 inherits the access criteria of the open asynchronous communication channel 1104. Similarly, the first marker 1112 and the second marker 1114 inherit the access criteria of the first synchronous communication session 1108. Accordingly, any member of the organization (Alice, Bob, or Charlie) may access the first synchronous communication session 1108 and the markers 1112, 1114.

Bob or Charlie launches a second synchronous communication session 1110 from the private asynchronous communication channel 1106, and during the second synchronous communication session 1110, a third marker 1116 and a fourth marker 1118 are created. The second synchronous communication session 1110 inherits the access criteria of the private asynchronous communication channel 1106. Similarly, the third marker 1116 and the fourth marker 1118 inherit the access criteria of the second synchronous communication session 1110. Accordingly, only members of the private asynchronous communication channel 1106 (Bob or Charlie) may access the second synchronous communication session 1110 and the markers 1116, 1118. Dan may not access any of the markers 1112-1118 or the synchronous communication sessions 1108, 1110.

Accordingly, after determining that a marker satisfies search criteria of a search request, the marker service may determine whether a user satisfies access criteria associated with the marker. The access criteria associated with the marker may be inherited from the synchronous communication session associated with the marker. Further, the access criteria of the synchronous communication session may be inherited from an associated asynchronous communication session. Thus, FIG. 11 illustrates how a relationships between a marker and a synchronous communication session may determine access criteria for the marker.

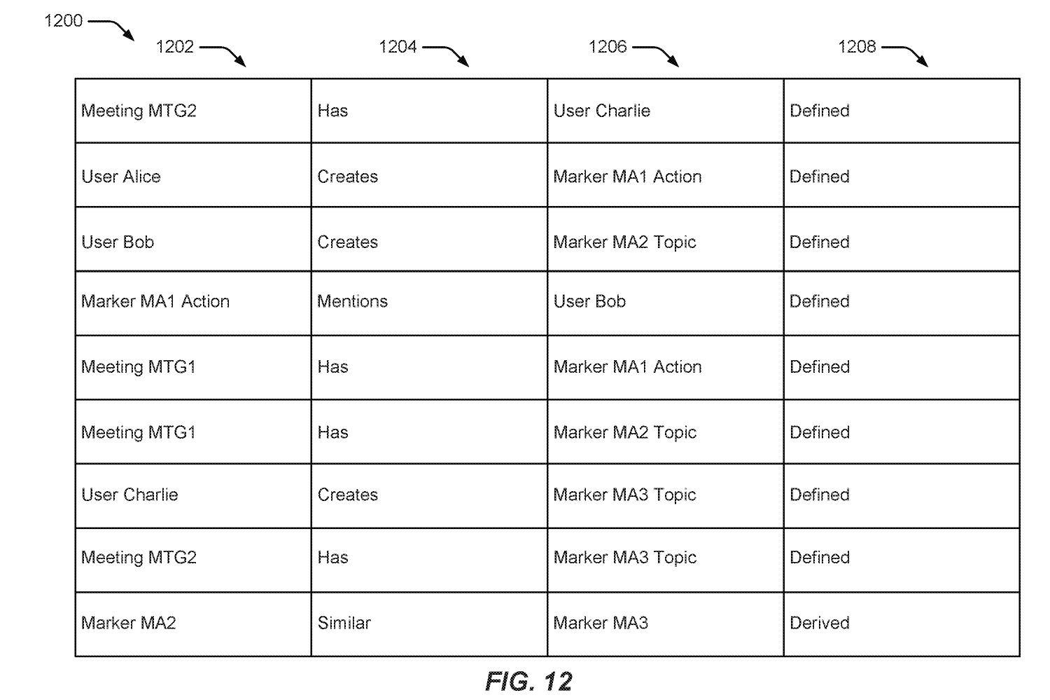

Referring to FIG. 12, a table 1200 illustrating relationships between logical entities associated with information is shown. The logical entities include individual users, synchronous communication sessions, and markers. Other examples of entities include organizations, teams, asynchronous communication channels, etc. The table 1200 is generated by a marker analytics module, such as the marker analytics module 316. A first column 1202 and a second column 1206 of the table 1200 identify lists of entities. A relation column 1204 identifies what types of relations exist between the entities of the first column 1202 and the entities of the second column 1206 and a defined column 1208 indicates whether the relations are defined or derived. For example, the analytics module may determine that a meeting MTG2 has a user Charlie. This relation is defined because the analytics module has access to evidence that the user Charlie participated in the meeting MTG2. The analytics module may further determine that a marker MA2 is similar to a marker MA3. The analytics module may determine the similarity of the markers based on how many associated keywords match. Because the similarity relation is calculated by the analytics module rather than definite, the relation is classified as derived.

The analytics module may determine relationships between entities from across an organization, including from different synchronous communication sessions (e.g., meetings). The relations identified by the analytics module may be used to provide various insights related to information generated by an organization. For example, a marker service may use the table 1200 to suggest markers related to a marker accessed by a user. Further, the table 1200 may be used by the marker service to identify markers that satisfy search criteria.

In an illustrative example, the marker service receives a search request from a searching device (e.g., one of the devices 120-124). The search request identifies search criteria (e.g., a keyword, a person, a topic, a marker, etc.). In some examples, the search criteria identifies a relation to an entity. For example, the search criteria may be “is similar to marker 1” or “was created by user 1.” The marker service identifies each marker that satisfies the search criteria in a marker database. As described above with reference to FIG. 11, the marker service identifies access criteria for each marker based on access criteria of corresponding asynchronous communication channels. The marker service then returns search results to the searching device, the search results including each marker that satisfies the search criteria for which the searching device satisfies the corresponding access criteria. The search results may include markers associated with different synchronous communication sessions.

Thus, FIG. 12 illustrates how markers and other entities may be analyzed and related to each other. Identified relations may be used by a marker service to identify search results and to provide other analytics.

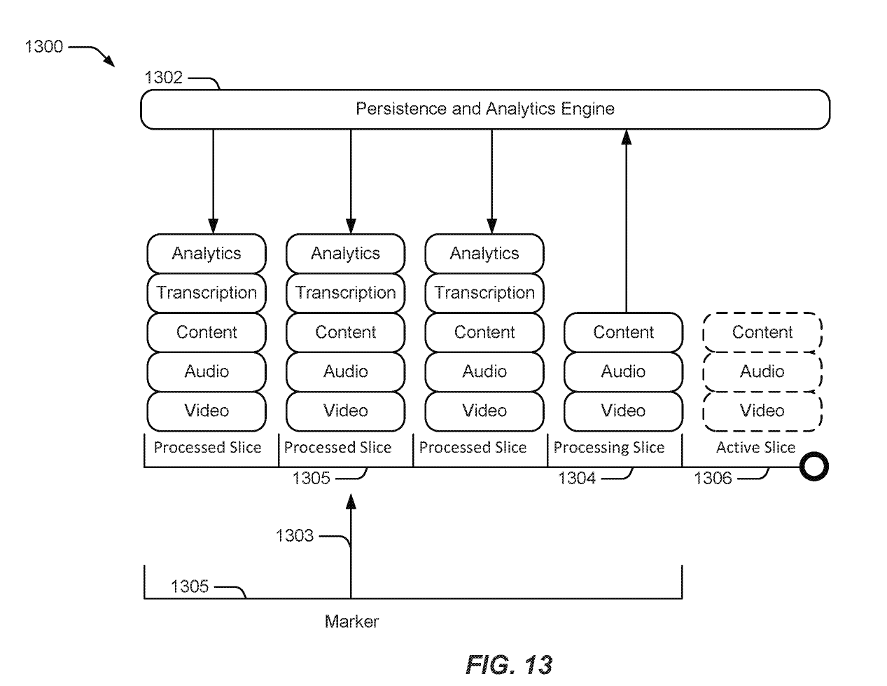

FIG. 13 illustrates a diagram 1300 depicting storage of data related to a synchronous communication session. As illustrated in FIG. 13, a persistence and analytics engine 1302 processes media data associated with a synchronous communication session in slices. The persistence and analytics engine 1302 may be executed by a computing device, such as the server device 102. Elements of the persistence and analytics engine 1302 may correspond to the marker analytics module 316 and/or the transcription service 908.

Video data, audio data, and content data associated with the synchronous communication session are stored in a storage device (e.g., the memory 106) in slices (e.g., 15 second time slice). As each slice is stored, the processing and analytics engine 1302 accesses the associated video data, audio data, and content data, and generates corresponding analytics and transcription data. The video data corresponds to video of participants in the synchronous communication session, the audio data corresponds to audio of participants in the synchronous communication session, and the content data corresponds to media (e.g., screen share data, slide show data) shared during the synchronous communication session. The transcription data corresponds to a transcription of the audio data and the analytics data corresponds to analytics associated with the slice. For example, the analytics may identify who participates during the slice, markers created during the slice, relations between entities associated with the slice, etc. In the illustrated example, a processed slice 1305 includes corresponding video data, audio data, content data, analytics data, and transcription data. The persistence and analytics engine 1302 is in the process of generating analytics data and transcription data for content data, audio data, and video data associated with a processing slice 1304. Further, content data, audio data, and video data associated with an active slice 1306 is being stored in the storage device.

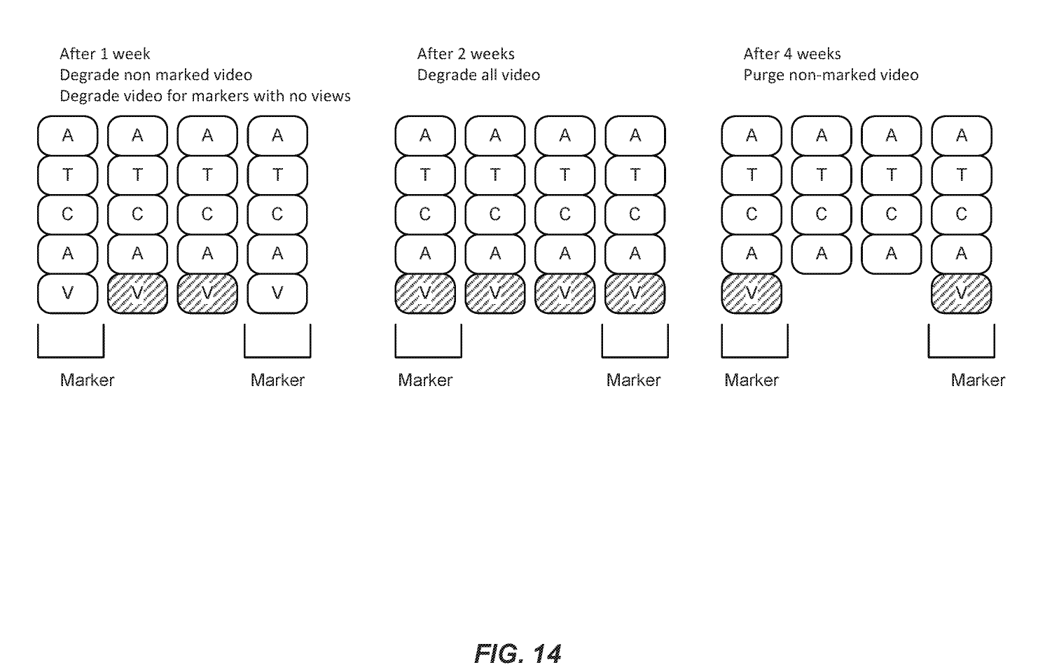

In the illustrated example, a marker 1303 is created during the processed slice 1305 and indicates a segment 1305 of the synchronous communication session. As described with reference to FIG. 14, the persistence and analytics engine 1302 determines a storage policy associated with data in the storage device based on markers. For example, the persistence and analytics engine 1302 may determine to maintain data past a storage time limit based on markers. As shown in FIG. 14, the persistence and analytics engine 1302 degrades video data included in unmarked segments but not video data included in marked segments after a first period of time (e.g., 1 week). After a second period of time (e.g., 2 weeks), the persistence and analytics engine 1302 degrades all video data. After a third period of time (e.g., 4 weeks), video data associated with un-marked segments is purged.

In some implementations, the video data is stored according to a scalable video coding (SVC) scheme. In such implementations, the video data includes baseline video data and enhancement layers. The enhancement layers may be used by a playback device to improve quality of playback based on the baseline video data. For example, the enhancement layers may be used to increase a frame rate associated with the playback, increase a resolution associated with the playback, increase a signal quality associated with the playback, or a combination thereof. In such implementations, degrading particular video data may include deleting one or more enhancement layers associated with the particular video data. In some implementations, degrading video data may include transcoding the video data to a lower quality. Accordingly, FIGS. 13 and 14 illustrate how markers may be used to efficiently manage data by maintaining video data of interest to an organization while freeing up storage space by degrading and deleting video data that may not be of interest to the organization.

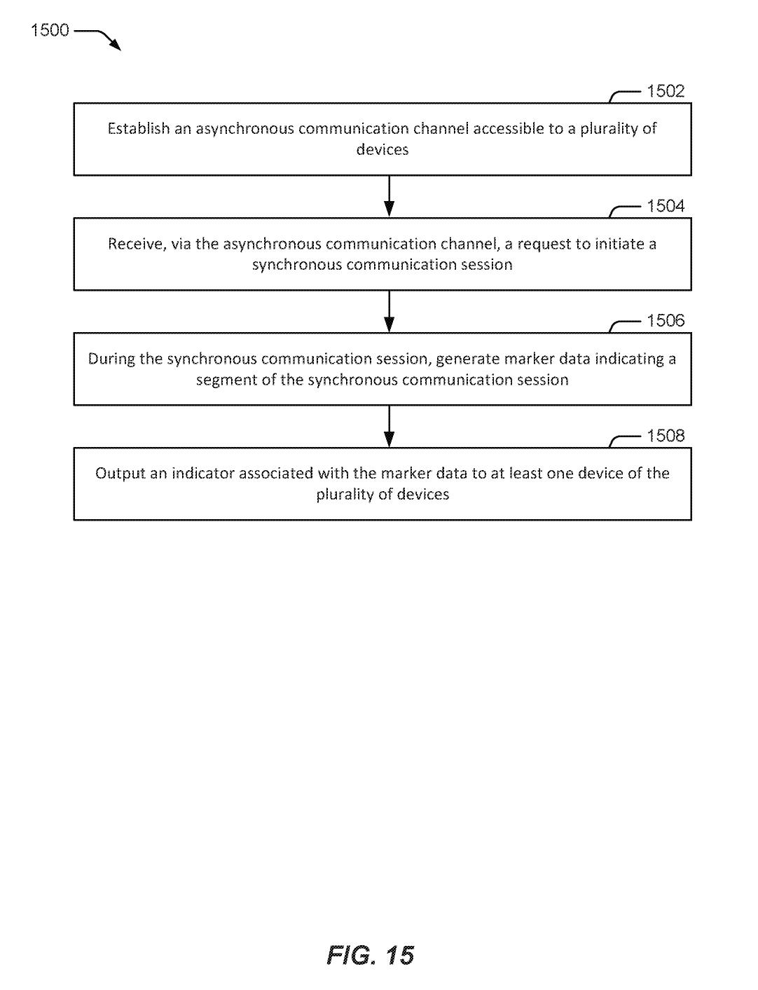

Referring to FIG. 15, a method 1500 of generating marker data is shown. The method 1500 may be performed by a server device, such as the server device 102. The method includes establishing an asynchronous communication channel accessible to a plurality of devices, at 1502. For example, the server device 102 may establish the asynchronous communication channel 126. The asynchronous communication channel 126 is accessible to the devices 120-124.

The method 1500 further includes receiving, via the asynchronous communication channel, a request to initiate a synchronous communication session, at 1504. For example, the server device 102 may receive the request 130 from the first device 120.

The method 1500 further includes, during the synchronous communication session, generate marker data indicating a segment of the synchronous communication session, at 1506. For example, the server device 102 may generate the marker data 112 during the synchronous communication session 128. The server device 102 may generate the marker data 112 based on user input received from one of the devices 120-124 or automatically.

The method 1500 further includes outputting an indicator associated with the marker data to at least one device of the plurality of devices, at 1508. For example, the server device 102 may transmit the indicator 132 indicating the marker data 112 to one or more of the devices 120-124 via the asynchronous communication channel 126 or via an alternate path.

Thus, FIG. 15 illustrates a method of generating marker data during a synchronous communication session. The marker data may facilitate reference and access to a segment of the synchronous communication session. Accordingly, information discussed during the synchronous communication session may be more easily maintained within an organization.

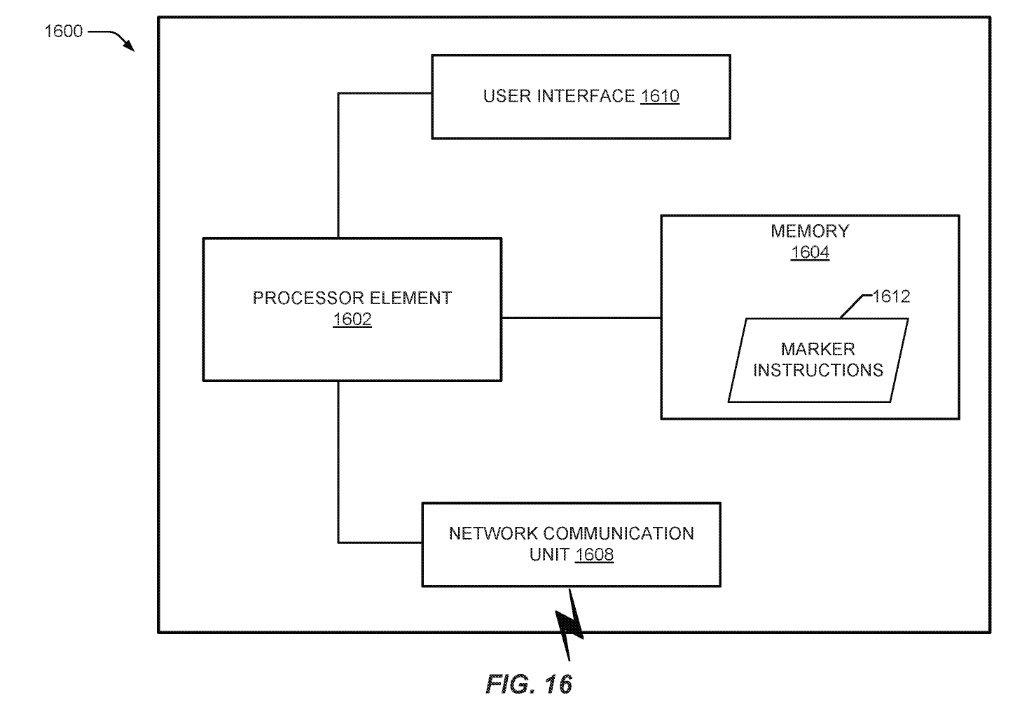

Referring now to FIG. 16, a block diagram illustrates a computing device 1600 that may be used for implementing the techniques described herein in accordance with one or more embodiments. For example, the computing device 1600 illustrated in FIG. 16 could represent a client device or a physical server device. In some implementations, the computing device 1600 corresponds to the server device 102 or one of the devices 120-124. As shown in FIG. 16, the computing device 1600 can include one or more input/output devices, such as a network communication unit 1608 that could include a wired communication component and/or a wireless communications component, which can be coupled to processor element 1602. The network communication unit 1608 can utilized any of a variety of standardized network protocols, such as Ethernet, TCP/IP, to name a few of many protocols, to effect communications between devices and comprise one or more transceiver(s) that utilize the Ethernet, power line communication (PLC), WiFi, and/or other communication methods.

The computing device 1600 includes a processor element 1602 that contains one or more hardware processors, where each hardware processor may have a single or multiple processor cores. In one embodiment, the processor element 1602 may include at least one shared cache that store data (e.g., computing instructions) that are utilized by one or more other components of processor element 1602. For example, the shared cache may be locally cache data stored in a memory for faster access by components of the processor element 1602. In one or more embodiments, the shared cache may include one or more mid-level caches, such as level 2 (L2), level 3 (L3), level 4 (L4), or other levels of cache, a last level cache (LLC), or combinations thereof. Examples of processors include, but are not limited to a central processing unit (CPU) a microprocessor. Although not illustrated in FIG. 16, the processor element 1602 may also include one or more other types of hardware processing components, such as graphics processing units (GPU), application specific integrated circuits (ASICs), field-programmable gate arrays (FPGAs), and/or digital signal processors (DSPs).

FIG. 16 illustrates that memory 1604 may be operatively coupled to processor element 1602. Memory 1604 may be a non-transitory medium configured to store various types of data. For example, memory 1604 may include one or more memory devices that comprise a non-volatile storage device and/or volatile memory. Volatile memory, such as random access memory (RAM), can be any suitable non-permanent storage device. The non-volatile storage devices can include one or more disk drives, optical drives, solid-state drives (SSDs), tap drives, flash memory, read only memory (ROM), and/or any other type memory designed to maintain data for a duration time after a power loss or shut down operation. In certain instances, the non-volatile storage device may be used to store overflow data if allocated RAM is not large enough to hold all working data. The non-volatile storage device may also be used to store programs that are loaded into the RAM when such programs are selected for execution. In the illustrated example, the memory 1604 stores marker instructions 1612. The marker instructions 1612 may be executable by the processor element 1602 to perform any of the operations or methods described with respect to FIGS. 1-15.

Persons of ordinary skill in the art are aware that software programs may be developed, encoded, and compiled in a variety computing languages for a variety software platforms and/or operating systems and subsequently loaded and executed by processor element 1602. In one embodiment, the compiling process of the software program may transform program code written in a programming language to another computer language such that the processor element 1602 is able to execute the programming code. For example, the compiling process of the software program may generate an executable program that provides encoded instructions (e.g., machine code instructions) for processor element 1602 to accomplish specific, non-generic, particular computing functions.

After the compiling process, the encoded instructions may then be loaded as computer executable instructions or process steps to processor element 1602 from storage (e.g., memory 1604) and/or embedded within the processor element 1602 (e.g., cache). The processor element 1602 can execute the stored instructions or process steps in order to perform instructions or process steps to transform the computing device into a non-generic, particular, specially programmed machine or apparatus. Stored data, e.g., data stored by a storage device, can be accessed by processor element 1602 during the execution of computer executable instructions or process steps to instruct one or more components within the computing device 1600.

A user interface 1610 can include a display, positional input device (such as a mouse, touchpad, touchscreen, or the like), keyboard, or other forms of user input and output devices. The user interface 1610 can be coupled to processor element 1602. Other output devices that permit a user to program or otherwise use the computing device can be provided in addition to or as an alternative to network communication unit 1608. When the output device is or includes a display, the display can be implemented in various ways, including by a liquid crystal display (LCD) or a cathode-ray tube (CRT) or light emitting diode (LED) display, such as an OLED display. Persons of ordinary skill in the art are aware that the computing device 1600 may comprise other components well known in the art, such as sensors, powers sources, and/or analog-to-digital converters, not explicitly shown in FIG. 16. For ease of discussion, FIG. 16 explanation of these other components well known in the art.

At least one embodiment is disclosed and variations, combinations, and/or modifications of the embodiment(s) and/or features of the embodiment(s) made by a person having ordinary skill in the art are within the scope of the disclosure. Alternative embodiments that result from combining, integrating, and/or omitting features of the embodiment(s) are also within the scope of the disclosure. Where numerical ranges or limitations are expressly stated, such express ranges or limitations may be understood to include iterative ranges or limitations of like magnitude falling within the expressly stated ranges or limitations (e.g., from about 1 to about 10 includes, 2, 3, 4, etc.; greater than 0.10 includes 0.11, 0.12, 0.13, etc.). The use of the term “about” means ±10% of the subsequent number, unless otherwise stated.

Use of the term “optionally” with respect to any element of a claim means that the element is required, or alternatively, the element is not required, both alternatives being within the scope of the claim. Use of broader terms such as comprises, includes, and having may be understood to provide support for narrower terms such as consisting of, consisting essentially of, and comprised substantially of. Accordingly, the scope of protection is not limited by the description set out above but is defined by the claims that follow, that scope including all equivalents of the subject matter of the claims. Each and every claim is incorporated as further disclosure into the specification and the claims are embodiment(s) of the present disclosure.

It is to be understood that the above description is intended to be illustrative, and not restrictive. For example, the above-described embodiments may be used in combination with each other. Many other embodiments will be apparent to those of skill in the art upon reviewing the above description. The scope of the invention therefore should be determined with reference to the appended claims, along with the full scope of equivalents to which such claims are entitled. It should be noted that the discussion of any reference is not an admission that it is prior art to the present invention, especially any reference that may have a publication date after the priority date of this application.

What is claimed is:

1. An apparatus comprising:
a processor; and
a computer-readable storage device storing instructions that, when executed by the processor, cause the processor to perform operations comprising:
establishing an asynchronous communication channel accessible to a plurality of devices;
receiving, via the asynchronous communication channel, a request to initiate a synchronous communication session;
during the synchronous communication session, generating marker data indicating a segment of the synchronous communication session; and
outputting an indicator associated with the marker data to at least one device of the plurality of devices.

2. A method comprising:
establishing, by a server device, an asynchronous communication channel accessible to a plurality of devices;
receiving, via the asynchronous communication channel, a request to initiate a synchronous communication session;
during the synchronous communication session, generating, at the server device, marker data indicating a segment of the synchronous communication session; and
outputting an indicator associated with the marker data to at least one device of the plurality of devices.

3. The method of claim 2, further comprising selecting the at least one device based on a type associated with the marker data.

4. The method of claim 3, wherein in response to the type corresponding to a personal type, the at least one device corresponds to one or more devices associated with a particular user indicated by the marker data.

5. The method of claim 3, wherein the at least one device corresponds to a user not participating in the synchronous communication session and not active in the asynchronous communication channel.

6. The method of claim 5, wherein the indicator includes a first invitation to access the segment via the at least one device and a second invitation to join the synchronous communication session.

7. The method of claim 6, wherein the indicator is sent to the at least one device via a short message service message or via an E-mail.

8. The method of claim 2, wherein outputting the indicator to the at least one device includes posting the indicator to the asynchronous communication channel.

9. The method of claim 2, further comprising, in response to receiving a reply associated with the indicator from the at least one device, adding a discussion thread associated with the marker data to the asynchronous communication channel.

10. The method of claim 2, wherein the at least one device is configured to update a display based on the indicator during the synchronous communication session.

11. The method of claim 2, wherein the synchronous communication session includes a video conference, and wherein the asynchronous communication channel includes a chatroom.

12. The method of claim 2, further comprising updating an enterprise application based on the marker data.

13. The method of claim 12, wherein the enterprise application comprises a calendar application, a workflow management application, an E-mail application, a text messaging application, or a combination thereof.

14. The method of claim 12, wherein the enterprise application is selected based on a type associated with the marker data.

15. The method of claim 14, further comprising receiving input from one of the plurality of devices during the synchronous communication session, the input defining the type and linking the type to the enterprise application.

16. A computer-readable storage device storing instructions that, when executed by a processor, cause the processor to perform operations comprising:
establishing, by a server device, an asynchronous communication channel accessible to a plurality of devices;
receiving, via the asynchronous communication channel, a request to initiate a synchronous communication session;
during the synchronous communication session, generating, at the server device, marker data indicating a segment of the synchronous communication session; and
outputting an indicator associated with the marker data to at least one device of the plurality of devices.

17. The computer-readable storage device of claim 16, wherein the operations further comprise:
receiving, from a natural language processing service, a list of one or more keywords associated with the segment; and
generating the marker data based on the one or more keywords.

18. The computer-readable storage device of claim 16, wherein the operations further comprise, before outputting the indicator, outputting a query to an administrator device, the query requesting confirmation of the marker data, wherein the indicator is output in response to receiving a confirmation from the administrator device.

19. The computer-readable storage device of claim 16, wherein the operations further comprise:
receiving, from a particular device of the plurality of devices, a message indicating user input received at the particular device during the synchronous communication session; and
generating the marker data based on the user input.

20. The computer-readable storage device of claim 16, wherein the operations further comprise storing the marker data in a database.

21. The computer-readable storage device of claim 20, wherein the operations further comprise:
receiving a search request from a searching device, the search request identifying search criteria;
determining that the marker data satisfies the search criteria;
determining access criteria associated with the asynchronous communication channel; and
in response to the searching device satisfying the access criteria, transmitting a search result indicating the marker data to the searching device.

22. The computer-readable storage device of claim 21, wherein the operations further comprise:
determining that second marker data stored in the database satisfies the search criteria, the second marker data associated with a second synchronous communication session that corresponds to a second asynchronous communication channel; and
in response to the searching device satisfying second access criteria associated with the second asynchronous communication channel, transmitting a second search result indicating the second marker data to the searching device.

23. The computer-readable storage device of claim 20, wherein the operations further comprise storing, in the database, an association between the marker data and one or more entities.

24. The computer-readable storage device of claim 23, wherein the operations further comprise determining analytics data based on the association, based on the marker data, or a combination thereof.

25. The computer-readable storage device of claim 23, wherein the one or more entities include an organization, a team, a user, the synchronous communication session, the asynchronous communication channel, other marker data, or a combination thereof.

26. The computer-readable storage device of claim 16, wherein the operations further comprise determining a storage policy for data associated with the segment based on the marker data indicating the segment.

27. The computer-readable storage device of claim 26, wherein the operations further comprise determining to maintain video data associated with the segment past a storage time limit in response to the marker data indicating the segment.

28. The computer-readable storage device of claim 16, wherein the operations further comprise, in response to receiving a selection of the indicator from a particular device, initiating transmission of media data associated with the segment to the particular device.
